(19) United States
(12) Patent Application Publication
(10) Pub. No.: US 2006/0254379 A1
(43) Pub. Date: Nov. 16, 2006

(54) Akrion solvent hood robot arm, non-warp modular design

(75) Inventor: Gregory Allen Burchyett, Rockwall, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/129,683

(22) Filed: May 13, 2005

(51) Int. Cl. B25J 18/00

(52) U.S. Cl. 74/490.01

(57) ABSTRACT

In a method and apparatus for handling semiconductor materials, a robot arm includes a tubular shaft having a distal end and a proximal end. A distal block disposed over the distal end is detachably secured to the distal end and a proximal block disposed over the proximal end is detachably secured to the proximal end. The tubular shaft, which has an adjustable length, is formed from a warp-resistant material that has sufficient strength to maintain a longitudinal axis alignment of the tubular shaft within a predefined tolerance. The distal block and the proximal block are customized to substantially match corresponding features of a legacy robot arm, thereby enabling a complete replacement of the legacy robot arm.

### BACKGROUND

The present disclosure relates generally to the fabrication of integrated circuits (ICs), and more particularly to a robot having an improved robot arm for handling semiconductor material.

Use of robots in the manufacturing of a variety of products ranging from automobiles to computers is well known. Robots generally increase the level of automation in the manufacturing process, thereby minimizing labor content to improve quality and reduce costs. Robots, which may be embedded in larger machinery such as wafer handling subsystems, are being widely used during the semiconductor fabrication process to perform operations such as pick-and-place, vision inspection, robotic testing, and the like. Robots may handle semiconductor materials varying from bare silicon wafers to packaged ICs. The bare silicon wafer may vary in size and is typically a starting point to fabricate one or more devices such as a microprocessor, a digital signal processor, a radio frequency chip, a memory and a microcontroller. Typical robot controlled material handling operations may include transferring, transporting, sorting, filling, loading, unloading, binning and storing.

FIG. 1A illustrates a view in perspective of a typical robot 110 included in a wet bench system 100, according to prior art. The wet bench system 100 typically cleans semiconductor wafers 102 and prepares them for further manufacturing processes such as etching and deposition. A non-depicted controller included in the robot 110 may be programmed to handle material. For example, sequentially transfer semiconductor wafers 102 that are loaded into a cassette 104 through a series of chemical baths, shown as tanks 120 through 150, to clean contaminants and remove residue. One or more dryers 160 may be included with the wet bench system 100 to dry off the wafers 102.

Three dimensional motion of the robot 110 may be precisely controlled by the controller by using electric actuator and/or stepper motors. A rail 170 may be used to guide the motion of the robot 110 as it moves the cassette 104 from tanks 120 through 150. The robot 110 includes a detachable robot arm 190 for handling the cassette 104. Several tens of silicon wafers may be stacked vertically in the cassette 104, which may weigh up to 50 pounds. Under the control of the robot 110, the robot arm 190 performs operations such as picking up a predefined object, e.g., the cassette 104, from a predefined location, transferring the object to a predefined target location and placing the object at the target location. Additional detail of the robot arm 190 is described in FIG. 1B.

FIG. 1B is a view in perspective of a typical robot arm 190 of FIG. 1A, according to prior art. The size and shape of the robot arm 190 shown, substantially resembles a rectangular prism having an elongated length 192, a height 194 and a depth 196. The exact dimensions of the robot arm 190 may vary depending on factors such as the make and model of the robot, wet bench dimensions, wafer size and similar others.

The robot arm 190 has a distal end portion 182 in the shape of a hook that interlocks into a corresponding matching slot (not shown) located on a main body portion of the robot 110. The robot arm 190 is detachably secured to the robot 110 by any suitable means such as screws. The robot arm 190 has a bifurcated proximal end portion 184 in the shape of a letter C. The specific size, shape and other features of the distal end portion 182 and the proximal end portion 184 may vary depending on each material handling application.

FIG. 1C is a block diagram illustrating additional detail of a coupling between the proximal end portion 184 and a cassette 104, according to prior art. For a pickup operation, the proximal end portion 184 of the robot arm 190 may be positioned to slide into a corresponding matching T structure 106 of the cassette 104, thereby enabling the robot arm 190 to pickup the cassette 104. The proximal end portion 184 includes a sensor 108 to detect a presence or absence of the cassette 104.

The robot arm 190 is generally fabricated from a single piece of plastic material and is non-modular in construction. Typical plastic material used includes PolyTetraFluoroEthylene (PTFE) and/or Polyvinylidene Fluoride (PVDF). However, the robot arm 190 is often susceptible to warping when subjected to semiconductor manufacturing process conditions, which may include high temperature, presence of corrosive vapors, tensile stress and the like. Uneven stress between an inner and an outer section of the robot arm 190 may lead to warping. The warping causes a distortion in the dimensions of the robot arm 190 that exceed a predefined tolerance. For example, the warping may cause the robot arm 190 to bend relative to its longitudinal axis, thereby causing a misalignment in the pick-and-place mechanism. The misalignment may result in improper material handling and may generate excessive scrap material. The problem may be further compounded by the non-availability of replacement robot arms to replace the warped robot arm, often resulting in shutting down the entire production line for several weeks.

Therefore, a need exists to provide an improved method and apparatus for handling semiconductor materials. Specifically, there is a need for a robot arm of a robot that is warp-resistant, is modular in construction, is adaptable to fit legacy equipment, and costs less compared to current warp sensitive robot arms. Accordingly, it would be desirable to provide an improved warp resistant robot arm, absent the disadvantages found in the prior techniques discussed above.

### SUMMARY

The foregoing need is addressed by the teachings of the present disclosure, which relates to an improved method and system for handling semiconductor materials. According to one embodiment, in a method and system for handling semiconductor materials, a robot arm includes a tubular shaft having a distal end and a proximal end. A distal block disposed over the distal end is detachably secured to the distal end and a proximal block disposed over the proximal end is detachably secured to the proximal end. The tubular shaft, which has an adjustable length, is formed from a warp-resistant material that has sufficient strength to maintain a longitudinal axis alignment of the tubular shaft within a predefined tolerance. The distal block and the proximal block are customized to substantially match corresponding features of a legacy robot arm, thereby enabling a complete replacement of the legacy robot arm.

In one aspect of the disclosure, a robot has a moveable robot arm for handling semiconductor material. The robot arm includes a tubular shaft having a distal end and a proximal end. A distal block is detachably coupled to the robot and disposed over the distal end. In addition, the distal block is detachably secured to the distal end. A proximal block is disposed over and is detachably secured to the proximal end. The proximal block includes an end-effector for the handling of the semiconductor material.

Several advantages are achieved by the method and system for handling semiconductor materials according to the illustrative embodiments presented herein. The embodiments advantageously provide for an improved robot arm that is warp-resistant, is modular in construction, is adaptable to fit legacy robotic equipment, and costs less compared to current warp sensitive robot arms. This advantageously enables manufacturers of ICs to timely and cost effectively replace warped and/or defective robot arms, often without shutting down the production line.

### BRIEF DESCRIPTION OF THE DRAWINGS

FIG. 1A described hereinabove, illustrates a view in perspective of a typical robot included in a material handling system, according to prior art;

FIG. 1B described hereinabove, illustrates a view in perspective of a typical robot arm of a robot in FIG. 1A, according to prior art;

FIG. 1C described hereinabove, is a block diagram illustrating additional detail of a coupling between a proximal end block and a cassette, according to prior art;

FIG. 2A illustrates a block diagram of a wet bench system with an improved robot arm, according to an embodiment;

FIG. 2B is an illustrative block diagram of an improved robot arm of FIG. 2A, according to an embodiment;

FIG. 2C is a view in perspective of a customized robot arm to replace a legacy robot arm of FIG. 1B, according to an embodiment; and

FIG. 3 is a flow chart illustrating a method of strengthening a robot arm, according to an embodiment.

### DETAILED DESCRIPTION

Novel features believed characteristic of the present disclosure are set forth in the appended claims. The disclosure itself, however, as well as a preferred mode of use, various objectives and advantages thereof, will best be understood by reference to the following detailed description of an illustrative embodiment when read in conjunction with the accompanying drawings.

Many traditional robot arms are constructed from a non-modular, single piece of plastic material. This often results in warping the robot arm when operating under harsh semiconductor manufacturing process conditions. The warping of the robot arm causes a misalignment in the pick-and-place mechanism of the robot and often results in generation of excessive scrap material. These problems may be addressed by an improved robot arm. In a method and system for handling semiconductor materials, the robot arm is improved by modularizing, strengthening and customizing its construction, thereby providing increased warp-resistance.

According to one embodiment, in a method and system for handling semiconductor materials, a robot arm includes a tubular shaft having a distal end and a proximal end. A distal block disposed over the distal end is detachably secured to the distal end and a proximal block disposed over the proximal end is detachably secured to the proximal end. The tubular shaft, which has an adjustable length, is formed from a warp-resistant material that has sufficient strength to maintain a longitudinal axis alignment of the tubular shaft within a predefined tolerance. The distal block and the proximal block are customized to substantially match corresponding features of a legacy robot arm, thereby enabling a complete replacement of the legacy robot arm.

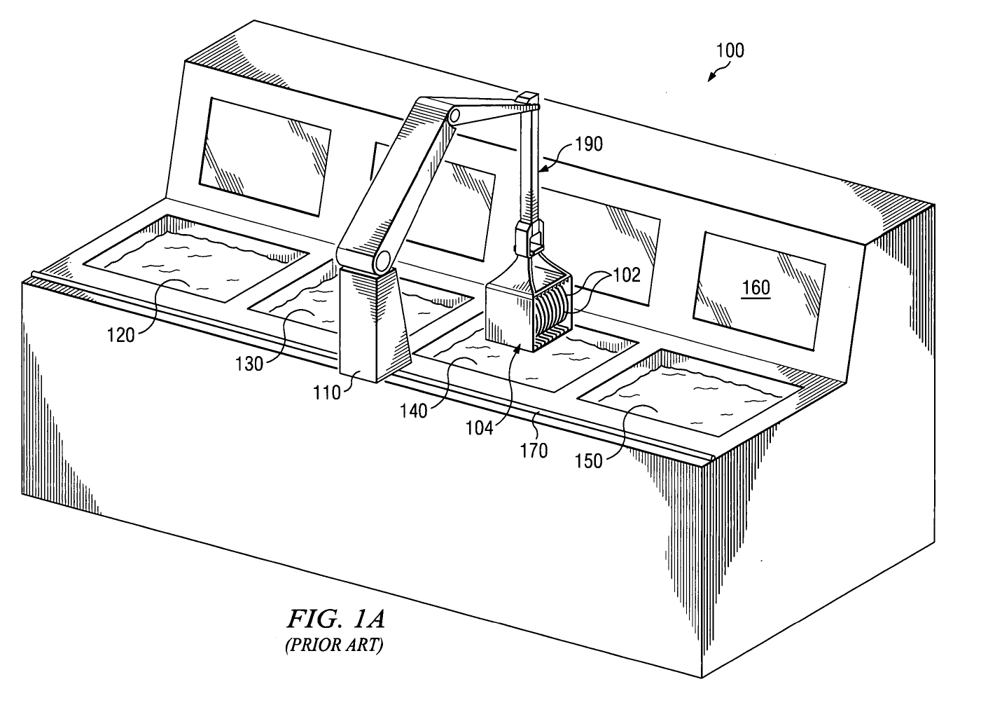

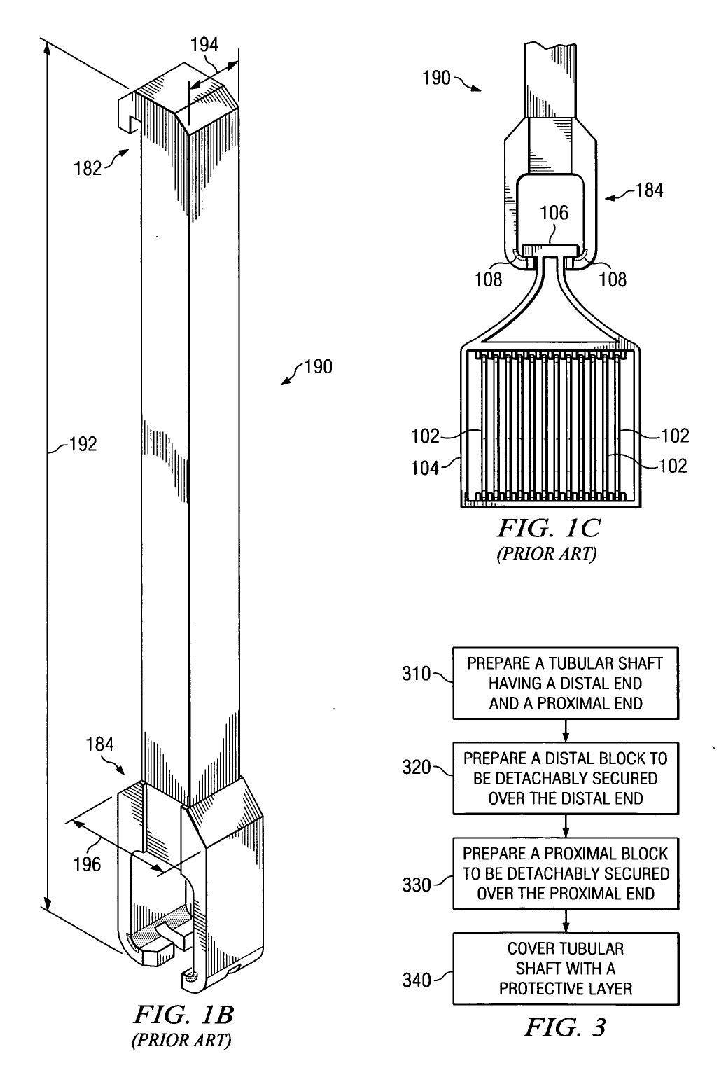

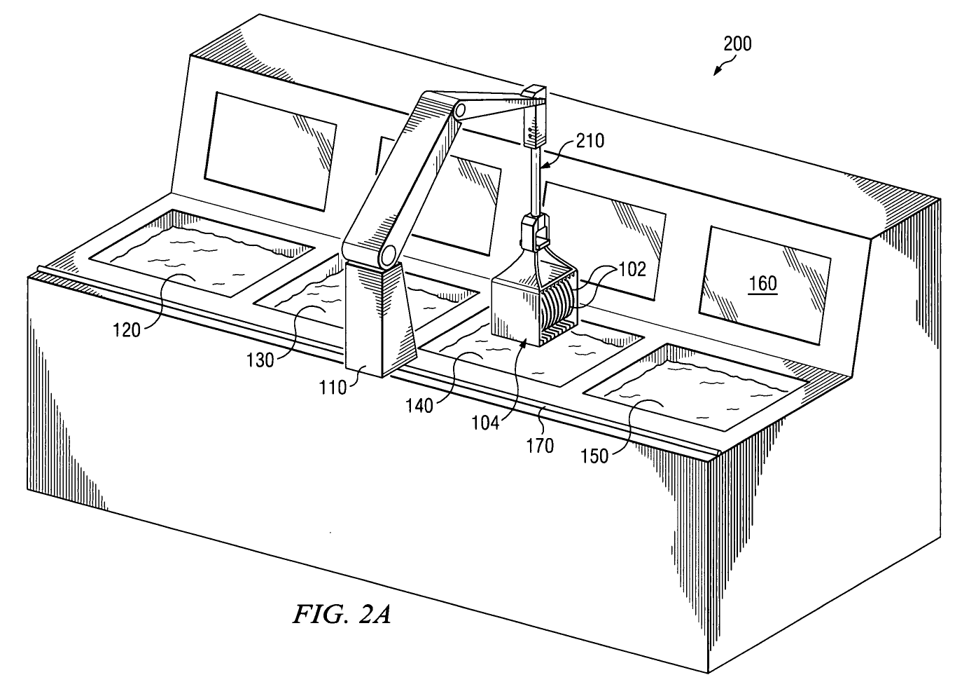

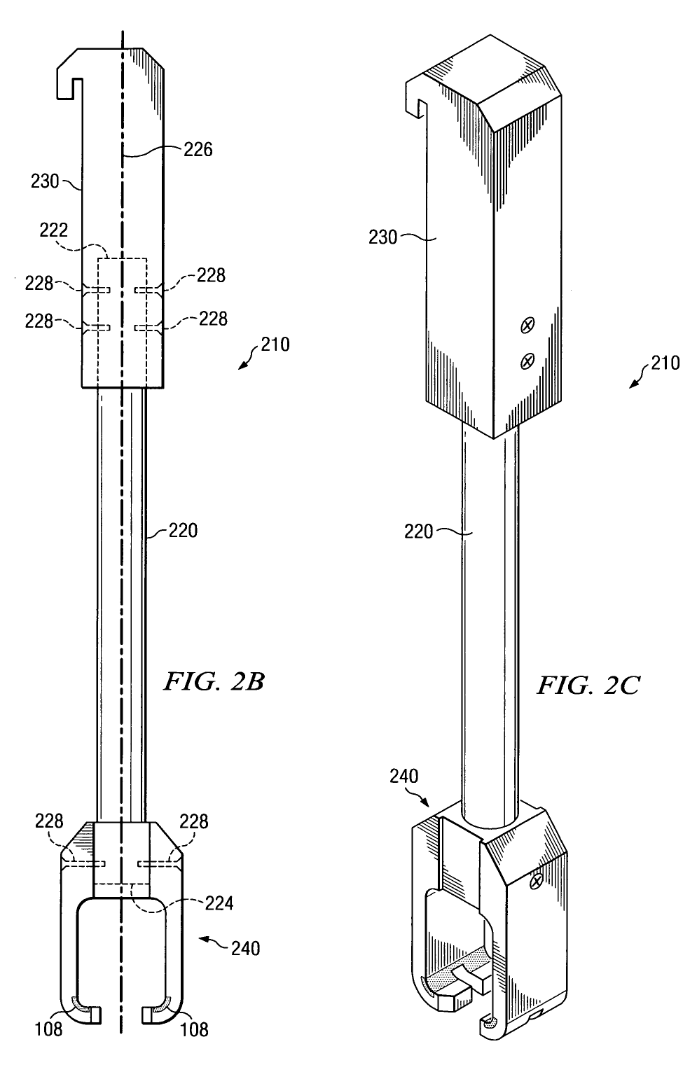

FIG. 2A illustrates a block diagram of a wet bench system 200 with an improved robot arm 210, according to an embodiment. In the depicted embodiment, the wet bench system 200 is substantially the same as the wet bench system 100 of FIG. 1A except for the improved robot arm 210.

FIG. 2B is an illustrative block diagram of an improved robot arm 210 of FIG. 2A, according to an embodiment. In the depicted embodiment, the improved robot arm 210 is modular in construction and includes a tubular shaft 220 having a distal end 222 and a proximal end 224. A distal block 230 is disposed over the distal end 222 in a detachably secured manner. In a particular embodiment, the distal block 230 may be detachably secured to the distal end 222 of the tubular shaft 220 by using a pressure fit. For example, a bore hole aligned with a longitudinal axis 226 of the tubular shaft 220 may be drilled into the distal block 230. An inner diameter of the bore hole in the distal block 230 substantially matches an outer diameter of the tubular shaft 220 to provide a pressure fit. A length of the bore hole is adjusted for obtaining a secure fit, while maintaining overall length. In a particular embodiment, the pressure fit between the distal block 230 and the tubular shaft 220 may be strengthened further by inserting a plurality of pins and/or screws 228 into corresponding aligned holes drilled in each one of the distal block 230 and the tubular shaft 220.

Similarly, a proximal block 240 is disposed over proximal end 224 in a detachably secured manner. In a particular embodiment, the proximal block 240 may be detachably secured to proximal end 224 of the tubular shaft 220 by using a pressure fit. For example, a bore hole aligned with the longitudinal axis 226 of the tubular shaft 220 may be drilled into the proximal block 240. An inner diameter of the bore hole in the proximal block 240 substantially matches an outer diameter of the tubular shaft 220 to provide a pressure fit. A length of the bore hole is adjusted for obtaining a secure fit, while maintaining overall length. In a particular embodiment, the pressure fit between the proximal block 240 and the tubular shaft 220 may be strengthened further by inserting the plurality of pins and/or screws 228 into corresponding aligned holes drilled in each one of the proximal block 240 and the tubular shaft 220.

The improved robot arm 210 is customizable for each material handling application. That is, each of the components of the improved robot arm 210 including the tubular shaft 220, the distal block 230 and the proximal block 240 may be adapted to substantially match dimensions and coupling specifications of the material handling application. In a particular embodiment, the improved robot arm 210 is customized to replace a legacy robot arm, e.g., the robot arm 190, that may be warped. The tubular shaft 220 has a customized length. That is, a particular length of the tubular shaft 220 is selected to substantially match a corresponding length of a legacy robot arm coupled to a legacy robot. In addition, a combined length of the distal block 230, the tubular shaft 220, and the proximal block 240 is customized to substantially match a corresponding length of a legacy robot arm. Similarly, each of the distal block 230 and the proximal block 240 is customized to substantially match a corresponding legacy top portion and a bottom portion of a legacy robot arm. The customization of the improved robot arm 210 advantageously preserves compatibility with legacy material handling systems. Additional details of an improved robot arm constructed to replace a legacy robot arm are described with reference to FIG. 2C.

Referring back to FIG. 2B, in a particular embodiment, the tubular shaft 220 is in the shape of a pipe or a tube having a hollow center, representative of a geometrically warp-resistant structure. In one embodiment, the geometrically warp-resistant structure of the tubular shaft 220 is further enhanced by use of an essentially warp-resistant material. For example, the tubular shaft 220 may be formed from the essentially warp-resistant material having sufficient strength to substantially maintain the dimensions of the robot arm 190 within a predefined tolerance level when subjected to semiconductor manufacturing process conditions. That is, the warp-resistant structure in combination with the warp-resistant material may have sufficient strength and rigidity to maintain an alignment of the longitudinal axis 226 of the tubular shaft 220 within a predefined tolerance. In a particular embodiment, the tubular shaft 220 is fabricated from known warp-resistant materials such as stainless steel, Polyvinylidene Fluoride (PVDF) plastic and the like. Thus, the improved robot arm 210 is substantially warp-resistant even when subjected to semiconductor manufacturing process conditions, which may include exposure to variations in temperature ranging from approximately 10° C. upto approximately 260° C., presence of corrosive vapors such as acid baths, tensile stress and the like. In corrosive material handling applications, the stainless steel material may be coated by a protective layer to provide increased resistance to corrosion.

In a particular embodiment, each of the proximal block 240 and the distal block 230 is formed from a plastic material such as PolyTetraFluoroEthylene (PTFE) plastic and Polyvinylidene Fluoride (PVDF) plastic. The proximal block 240 and the distal block 230 formed from the PVDF material may provide improved resistance to warping compared to the PTFE material.

In a particular non-depicted embodiment, the proximal block 240 or a portion thereof may include an end-effector for performing at least one predefined function such as a pick-and-place operation. An end-effector is a device or tool connected to an end of a robot arm. Typical examples of an end-effector may include grippers, tool changers, position/touch sensors, rotary joint, paint gun, arc welding gun, and the like. In a depicted embodiment, the end-effector portion of the proximal block 240 is customized to make it substantially similar to the bifurcated proximal end portion 184 in the shape of a letter C of FIG. 1C. In this embodiment, the end-effector includes the sensor 108 to detect a presence of a load such as the cassette 104 coupled to the end-effector. Components such as mechanical levers, links and electrical wiring for the sensors 108 may be routed through a hollow center portion of the tubular shaft 220 to a controller of the robot.

FIG. 2C is a view in perspective of a customized robot arm to replace a legacy robot arm 190 of FIG. 1B, according to an embodiment. In the depicted embodiment, the improved robot arm 210 is customized to substantially match the overall dimensions and coupling specifications of the legacy robot arm 190. As described earlier, a particular length of the tubular shaft 220 is selected to substantially match a corresponding length of the legacy robot arm 190. In addition, a combined length of the distal block 230, the tubular shaft 220, and the proximal block 240 is customized to substantially match a corresponding length of the legacy robot arm 190. Similarly, each of the distal block 230 and the proximal block 240 is customized to substantially match a corresponding legacy distal end portion 182 and a bottom legacy bifurcated proximal end portion 184.

In addition to the wet bench system 200 described with reference to FIGS. 2A, 2B and 2C, the use of the improved robot arm 210 is also contemplated with other semiconductor material handling systems such as robotic systems for transferring, transporting, sorting, filling, loading, unloading, binning and storing semiconductor wafers.

FIG. 3 is a flow chart illustrating a method of strengthening a robot arm, according to an embodiment. At step 310, a tubular shaft having a distal end and a proximal end is prepared. In a particular embodiment, preparing the tubular shaft may include cutting a pipe or a tube to a predefined length, the pipe or the tube being fabricated from an essentially warp-resistant material. At step 320, a distal block is prepared to be detachably secured over the distal end. At step 330, a proximal block is prepared to be detachably secured over the proximal end.

Various steps described above may be added, omitted, combined, altered, or performed in different orders. For example, an additional step may be added to protect the tubular shaft. At step 340, the tubular shaft may be covered with a protective layer for improved corrosion resistance.

Although illustrative embodiments have been shown and described, a wide range of modification, change and substitution is contemplated in the foregoing disclosure and in some instances, some features of the embodiments may be employed without a corresponding use of other features. Those of ordinary skill in the art will appreciate that the hardware and methods illustrated herein may vary depending on the implementation. For example, although the disclosure is described in the context of a robot based semiconductor wafer handling system, this disclosure is not limited to use with semiconductor wafers; rather, it envisions use of an improved robotic arm with any and all robot based material handling systems.

The methods and systems described herein provide for an adaptable implementation. Although certain embodiments have been described using specific examples, it will be apparent to those skilled in the art that the invention is not limited to these few examples. The benefits, advantages, solutions to problems, and any element(s) that may cause any benefit, advantage, or solution to occur or become more pronounced are not to be construed as a critical, required, or an essential feature or element of the present disclosure.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A robot arm apparatus to handle a semiconductor material, the apparatus comprising:
a tubular shaft having a distal end and a proximal end;
a distal block disposed over the distal end, wherein the distal block is detachably secured to the distal end; and
a proximal block disposed over the proximal end, wherein the proximal block is detachably secured to the proximal end, wherein the proximal block is operable to handle the semiconductor material.

2. The robot arm apparatus of claim 1, wherein the tubular shaft has a customized length.

3. The robot arm apparatus of claim 1, wherein the tubular shaft is formed from an essentially warp-resistant material, the essentially warp-resistant material having sufficient strength to maintain a longitudinal axis alignment of the tubular shaft within a predefined tolerance.

4. The robot arm apparatus of claim 3, wherein the essentially warp-resistant material is one of stainless steel and a Polyvinylidene Fluoride (PVDF) plastic.

5. The robot arm apparatus of claim 4, wherein the stainless steel is coated by a protective layer, the protective layer providing increased resistance to corrosion.

6. The robot arm apparatus of claim 1, wherein the proximal block is formed from a plastic material, wherein the plastic material is one of a PolyTetraFluoroEthylene (PTFE) plastic and a Polyvinylidene Fluoride (PVDF) plastic.

7. The robot arm apparatus of claim 1, wherein the distal block is formed from a plastic material, wherein the plastic material is one of a PolyTetraFluoroEthylene (PTFE) plastic and a Polyvinylidene Fluoride (PVDF) plastic.

8. The robot arm apparatus of claim 1, wherein each one of the distal block and the proximal block is detachably secured to the tubular shaft by a pressure fit, wherein the pressure fit is further strengthened by inserting a plurality of pins or screws into corresponding aligned holes drilled in each one of the distal block, the proximal block, and the tubular shaft.

9. The robot arm apparatus of claim 1, wherein the distal block is customized to substantially match a corresponding legacy top portion coupled to a legacy robot.

10. The robot arm apparatus of claim 1, wherein the proximal block is customized to substantially match a corresponding legacy bottom portion of a legacy robot arm.

11. The robot arm apparatus of claim 1, wherein a combined length of the distal block, the tubular shaft, and the proximal block coupled is customized to substantially match a corresponding length of a legacy robot arm.

12. The robot arm apparatus of claim 1, wherein the tubular shaft has a geometrically warp-resistant structure, wherein the geometrically warp-resistant structure includes a tube having a hollow center, wherein the hollow center provides a path to route a component used for handling the semiconductor material.

13. The robot arm apparatus of claim 1, wherein the robot arm is included in a semiconductor material handling system operable to transfer the semiconductor material from a first location to a second location.

14. The robot arm apparatus of claim 1, wherein the semiconductor material is a silicon wafer to fabricate at least one of a microprocessor, a digital signal processor, a radio frequency chip, a memory and a microcontroller.

15. An apparatus comprising:
a robot having a moveable robot arm for handling semiconductor material, wherein the robot arm includes:
a tubular shaft having a distal end and a proximal end;
a distal block detachably coupled to the robot and disposed over the distal end, wherein the distal block is detachably secured to the distal end; and
a proximal block disposed over the proximal end, wherein the proximal block is detachably secured to the proximal end, wherein the proximal block includes an end-effector for the handling of the semiconductor material.

16. The apparatus of claim 15, wherein the semiconductor material is a silicon wafer to fabricate at least one of a microprocessor, a digital signal processor, a radio frequency chip, a memory and a microcontroller.

17. The apparatus of claim 15, wherein the tubular shaft is formed from an essentially warp-resistant material, the essentially warp-resistant material having sufficient strength to maintain a longitudinal axis alignment of the tubular shaft within a predefined tolerance.

18. A method of strengthening a robot arm operable to handle a semiconductor material, the method comprising:
preparing a tubular shaft having a distal end and a proximal end;
preparing a distal block to be detachably secured over the distal end; and
preparing a proximal block to be detachably secured over the proximal end, wherein the proximal block is operable to handle the semiconductor material.

19. The method of claim 18, wherein the tubular shaft is prepared by cutting a pipe to a predefined length, the pipe being made from an essentially warp-resistant material having sufficient strength to maintain a longitudinal axis alignment of the tubular shaft to be within a predefined tolerance.

20. The method of claim 18, wherein the essentially warp-resistant material is coated by a protective layer, the protective layer providing increased resistance to corrosion.
